(19) United States
(12) Patent Application Publication
(10) Pub. No.: US 2008/0025811 A1
(43) Pub. Date: Jan. 31, 2008

(54) METHOD FOR STRUCTURAL ATTACHMENT USING A BLIND RIVET, BLIND RIVET ENABLING THE METHOD TO BE IMPLEMENTED AND FITTING TOOL SUITABLE FOR SUCH A RIVET

(76) Inventors: Jean-Marc Auriol, Flourens (FR); Pierre Auriol, Flourens (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/780,598

(22) Filed: Jul. 20, 2007

(30) Foreign Application Priority Data
Jul. 25, 2006 (FR) 0653114

(51) Int. Cl. F16B 13/04

(52) U.S. Cl. 411/43; 29/243.526

(57) ABSTRACT

The invention relates to a method for structural attachment using a blind rivet (R) including a rod (100) that, equipped with a head (110) and a threaded portion (120), is arranged inside a hollow dowel (200) including a first end equipped with a head (210) and a second end (220) on which a nut (330) cooperating with the threaded portion of the rod (100) exerts a force transmitted by the rod (100) so that a second bearing surface on the second element is created by deformation, which is remarkable in that it consists of
imparting a first translation movement (arrow F1) on the rod (100) so as to create, by deformation under the action of said nut, said second bearing surface, then
imparting a second rotation movement (arrow F4) on said rod (100) for the purpose of screwing, so as to apply a tension in the attachment created. The invention also relates to the rivet enabling such a method to be implemented, as well as the fitting tool adapted to said rivet.

### FIELD OF APPLICATION OF THE INVENTION

This invention relates to the field of blind rivets with or without a countersunk head and in particular to adaptations making it possible to optimise their use and the attachment that they provide.

### DESCRIPTION OF THE PRIOR ART

To prevent the attachment head from forming a projection above the surface of the part to be attached, the prior art describes blind rivets with a countersunk head composed of a threaded rod, a hollow dowel and a nut. This assembly is for example inserted into two coaxial holes formed in elements intended to be attached. One of these coaxial holes is preformed with a countersink corresponding to the volume of the countersunk head of the dowel. The attachment method conventionally consists of rotating the rod with respect to the dowel so as to cause the nut to move toward the head and to create, by expansion of the dowel or the nut, a bulb making it possible to provide a second bearing surface that, by approaching the head of the dowel, will ensure the desired attachment. The use of a helical connection allows for a rotation movement in order to ensure the translation movement necessary for the attachment. In addition, the screwing makes it possible to apply a tightening force, a tension, in the attachment once the two bearing surfaces have been created.

Nevertheless, this rivet and method have the disadvantages of requiring projecting or retracted volumes on the external surface of the dowel head so as to lock it in rotation when the rod is screwed. Similarly, when it is possible in the prior art for a head to be placed above the surface of the part to be attached, this head also has projecting or retracting volumes or bearing planes for a fitting and tightening tool so as to prevent the rotation of the dowel during positioning.

In addition, the applicants have noted in the rivets of the prior art that the breakage of the threaded rod necessary to prevent the projection of the latter with respect to the head left a projecting volume at the level of said head.

These projecting or retracting volumes offer wind resistance defining an irregular aerodynamic drag that aeronautical manufacturers try to avoid.

### DESCRIPTION OF THE INVENTION

Based on this state of fact, the applicants have conducted research to avoid the presence of projecting or retracted volumes on the external surface of the dowel head, whether these volumes are associated with the dowel or the threaded rod.

This research has led to the design of a novel and inventive method for structural attachment by a blind rivet that overcomes the disadvantages of the prior art and requires a rivet having adapted features.

According to the invention, the method for structural attachment of at least two elements in which attachment apertures are provided and made coaxial, uses a blind rivet positioned in the attachment apertures and including a rod that, equipped with a head and a threaded portion, is inserted into a hollow dowel including a first end equipped with a head that constitutes a first bearing surface on a first element, and a second end on which a nut cooperating with the threaded portion of the rod exerts a force transmitted by the rod so that a second bearing surface on the second element is created by deformation.

This method is remarkable in that it consists of:
imparting a first translation movement on the rod so as to create, by deformation under the action of said nut, said second bearing surface cooperating with the surface defined by the dowel head in order to assume the attachment between the two elements, then
imparting a second rotation movement on said rod for the purpose of screwing, so as to apply a tension in the attachment created.

The tensile force is therefore not exerted by means of a helical connection, but directly on the stationary rod associated with the nut. The preliminary tensile force makes it possible to guarantee good contact between the nut and the elements to be attached. This tensile force also ensures a good flow of the sealing compound optionally present between the elements to be tightened. In addition, the tensile force ensures the deformation of a plurality of parts of the rivet, which contributes to the locking thereof in rotation, a feature essential to the next step of screwing. This locking in rotation no longer makes it necessary to have projecting or retracting volumes on the dowel head so as to enable the fitting tool to lock the latter in a helical movement of the threaded rod. The upper surface of the dowel therefore remains free of any projecting or retracted volume having the function of locking it in rotation. This feature therefore enables the drag to be improved.

According to another feature, the method is based on a blind rivet with a countersunk head constituted by a rod that, equipped with a countersunk head and a threaded portion, is arranged inside a hollow dowel including a first end externally adopting the form of a countersunk head constituting a first bearing surface and preformed internally by a conical volume in order to receive the countersunk head of the rod, and a second end on which a nut cooperating with the rod exerts a tensile force transmitted by the rod so that a second bearing surface is created by deformation.

According to the main feature of the invention, the method is remarkable in that it consists of:
imparting a first translation movement on the rod so as to create, by deformation, said second bearing surface cooperating with the surface defined by the countersunk head of the dowel in order to assume the attachment, then
imparting a second rotation movement on said rod for the purpose of screwing, so as to apply a tension in the attachment created.

The attachment method of the invention, which is suitable for a countersunk rivet, i.e. a rivet including at least one dowel with a countersunk head, proposes an attachment without any projecting or retracted volume opposite the external surface of the first element to be attached, itself equipped with a countersink.

A solution proposed by the method of the invention lies in the fact that, according to a particularly advantageous feature, the tensile force ensures the tight assembly of the dowel inside at least the first traversed element to be attached. This feature optimises the locking in rotation of the body of the dowel for the next step of screwing.

The deformation of the dowel or the nut for the purpose of creating a bulb forming the second bearing surface can be performed according to various methods.

The invention also relates to the rivet suitable for the implementation of the method of the invention. According to the invention, the rivet is remarkable in that it comprises a rod for actuation associated with the head of the rod by means of a connection zone of which the cross-section is defined so as to facilitate its breakage once a tightening torque has been achieved. This connection rod adopts a configuration allowing its tensile as well as its rotational movement. According to a particularly advantageous feature, this actuation rod comprises an external surface preformed with a threading.

According to another particularly advantageous feature of the invention, the tightening force by screwing is continued until the actuation rod breaks. A breakage by rotation at the end of the attachment operation makes it possible to minimise the effect of elastic return of the material and makes it possible to apply a better tension, i.e. a better tightening in the structural attachment implemented. This feature avoids, once the separation has been performed, the presence of any projecting or retracted form on the head of the threaded rod.

According to another particularly advantageous feature of the invention, the dowel adopts a bulge under its head so that the dowel head requires an additional force for its insertion into the aperture provided for receiving it in the part to be attached. According to a technological choice, this bulge consists of a portion with a limited length and a diameter greater than the cylindrical portion of the aperture receiving the dowel.

According to another particularly advantageous but non-limiting feature of the invention, the nut and/or the end of the dowel with which it comes into contact adopt surfaces opposing said rotation once the deformation has been achieved. These surfaces can be grooves or planar surface blocking any rotation while allowing for the aforementioned expansion.

According to another particularly advantageous feature of the invention, the blind rivet is remarkable in that the external surface of the dowel head has a planar surface coming to the same height as the surface of the element to be attached and not comprising any projecting or retracted volume.

Another object of the invention relates to the fitting tool and in particular the nose for fitting said rivet implementing said method, which fitting nose is remarkable in that it is constituted by:
a stationary body coming into contact, on each side of the actuation rod, with the external surface of the dowel head;
an actuation member housed in the body and capable of being moved in translation and in rotation so as to cause the movement of a gripping member with which the actuation rod cooperates.

According to another particularly advantageous feature, the gripping member housed in the actuation member is equipped with an internal threading with which the actuation rod engages, which rod is itself threaded so as to be secured to said member upon the transmission of the translation and rotation movement. This choice of a helical connection for transmission of a movement not only in translation, but also in rotation, makes the production of the actuation rod particularly simple.

As the basic concepts of the invention have been described above in their most basic form, other details and features will become more clear on reading the following description, and with regard to the appended drawings, provided as a non-limiting example, of an embodiment of a method, a rivet and a fitting tool according to the invention.

### BRIEF DESCRIPTION OF THE DRAWINGS

FIG. 1 is a diagrammatic drawing of a cross-section view of an embodiment of a rivet-type attachment according to the invention.

FIG. 2 is a diagrammatic drawing of a cross-section view of another embodiment of a rivet-type attachment according to the invention.

FIGS. 3, 4, 5 and 6 show the method of the invention.

FIG. 7 is a diagrammatic drawing of a top view of the established attachment.

FIG. 8 is a cross-section view of two other embodiments of a rivet-type attachment according to the invention.

FIGS. 9 and 10 show a part of the method of the invention on the basis of these embodiments.

FIG. 11 is a diagrammatic drawing of a cross-section view of an embodiment according to the invention of a fitting tool associated with said rivet of the invention.

### DESCRIPTION OF PREFERRED EMBODIMENTS

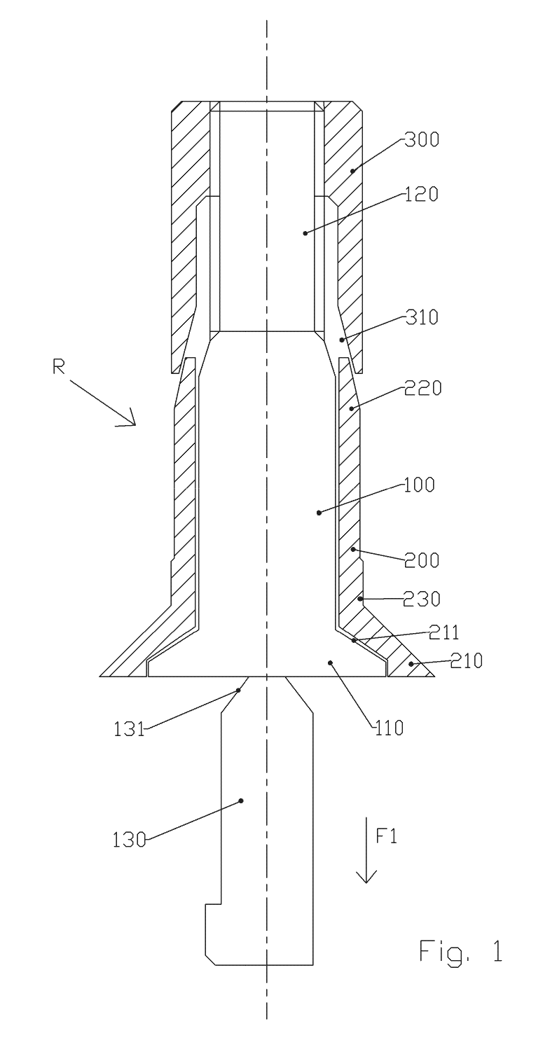

As shown in the drawing of FIG. 1, the blind rivet of the invention referenced R as a whole includes a rod 100 equipped with a countersunk head 110 and a threaded portion 120, which is arranged inside a hollow dowel 200 including a first end externally adopting the form of a countersunk head 210 constituting a first bearing surface and internally preformed by a conical volume 211 for receiving the countersunk head 110 of the rod 100, and a second end 220 on which a nut 300 cooperating with the rod 100 exerts a tensile force transmitted by the rod 100 and shown by the arrow F1 so that a second bearing surface is created by deformation.

As shown, the head 110 of the rod 100 is associated with an actuation rod 130 by means of a breakage zone 131.

As shown, the second end 220 of the dowel 200 and the end 310 of the nut 300 coming into contact with it are preformed so that under the action of a tensile force imparted by the translation movement of the rod 100, said nut is deformed around the second end 220 of the dowel 200 so as to create the second bearing surface. To implement this expansion, said second end adopts a male frustoconical shape with which a frustoconical female shape, formed in the end 310 of the nut 300 coming into contact with the second end of the dowel, cooperates.

According to another embodiment not shown, the nut 300 and the dowel 200 are preformed so that under the action of the tensile force transmitted by the rod, the second end 200 of the dowel expands. To this end, the second end adopts a female shape with which a male shape adopted by said not cooperates.

As shown, the rod 120 is threaded only at its end so as to be helically connected only to the nut 300 and adopts a sliding pivot-type connection with the dowel 200.

The method for establishing the attachment constituted by this rivet is remarkable in that it consists of imparting a direct tensile force on the threaded rod so as to deform the dowel or the nut so as to create a second bearing surface before imparting a rotation movement on said threaded rod for the purpose of screwing in order to apply a tension in the attachment created.

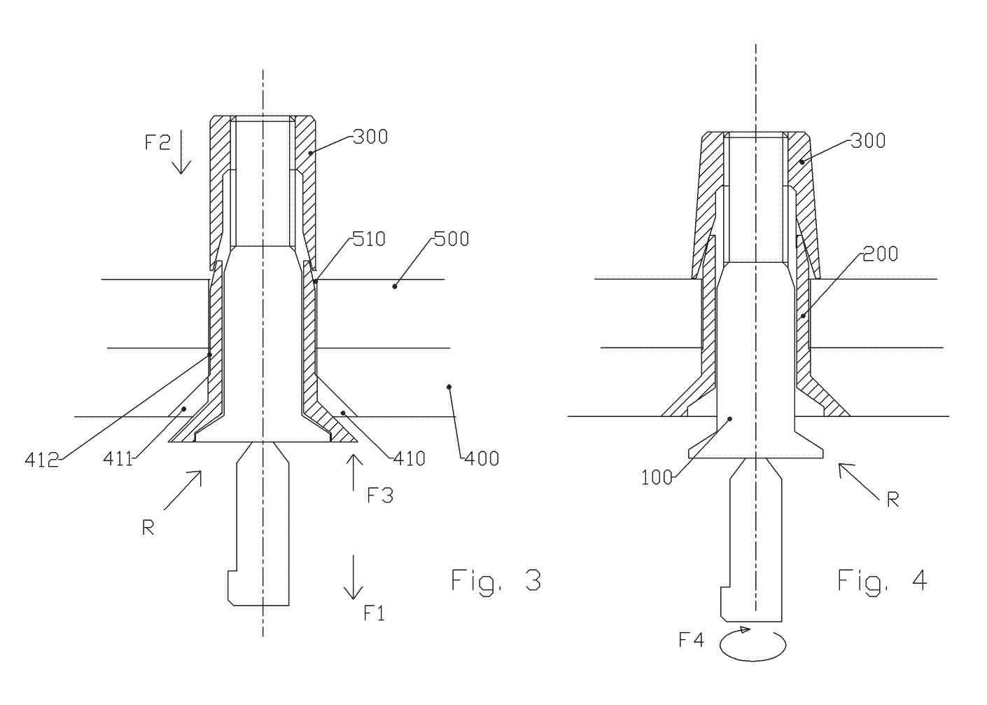

This method is shown by the drawings of FIGS. 3, 4, 5 and 6.

FIG. 3 shows the positioning of the blind rivet R inside the coaxial apertures 410 and 510 produced in sheets 400 and 500 of which the rivet ensures the attachment. As shown, the aperture 410 formed in the first sheet 400 is formed in a countersink 411 for receiving the countersunk head 210 of the dowel 200 of the rivet R extended by a cylindrical hole 412.

According to the invention, a portion 230 of the dowel 400 located under the countersunk head 210 adopts a diameter greater than that of a cylindrical hole 412 extending the countersink 411 of the aperture 410. In the first positioning movement, this portion 230 comes into contact on the edge of the cylindrical hole 412.

Under the action of a simple tensile force symbolised by the arrow F1 exerted on the rod 100 and transmitted to the nut 300, the nut 300 will expand on the dowel 200 and approach (arrow F2) the dowel head so that its end 310 comes into contact with the surface of the sheet 500. The continuous tensile force then ensures a relative movement (arrow F3) of the dowel toward the nut locked in translation, which relative movement ensures the tight assembly between the dowel 200 and the first sheet 400.

According to a preferred embodiment, the length of the portion 230 and its diameter are constant regardless of the thickness of the assembly to be attached, so that the fitting force is not modified.

The tight assembly of the dowel 200 eliminates the need for the presence of projecting or retracted volumes on the head 210 of the dowel 200 with which the fitting tool could cooperate so as to prevent its rotation.

The position obtained after tensile force is shown by the drawing of FIG. 4, in which the countersunk head 210 of the dowel 200 fills the free volume of the countersink 411 and in which the nut 300 forms a second bearing surface of which the approach with that defined by the countersunk head ensures the good mutual attachment of the sheets 400 and 500. As shown, the head of the rod 100 is then located outside of the dowel 200.

Once the position of FIG. 4 has been obtained, the second step of the method can begin, namely the application of a tightening tension by screwing. The rotation movement (arrow F4) is imparted on the actuation rod 130 so that the rod 100 penetrates the dowel through its helical connection with the nut 300 until it reaches the position shown by the drawing of FIG. 5. To prevent any rotation of said nut 300 in spite of the deformation due to the first tensile force step, the nut 300 and/or the frustoconical end 220 of the dowel on which it comes into contact and expands adopt surfaces opposing said rotation, such as grooves or planar surfaces blocking any rotation once the nut 300 has expanded.

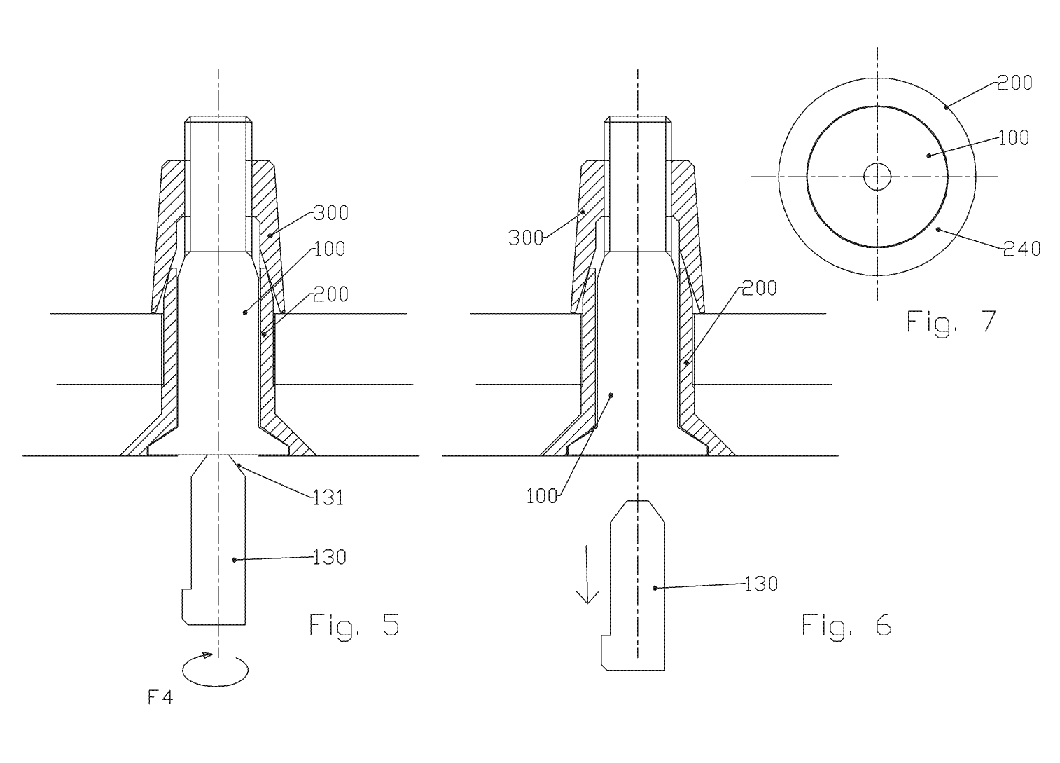

As shown in FIG. 6, the screwing for tightening can continue until it reaches a certain torque causing the breakage of the zone of connection 131 with the shaft 130. This breakage leaves the head 110 of the rod 100 inscribed in the head 210 of the dowel 200 without any projecting or retracted volume, in accordance with the objectives of the invention. FIG. 7 shows, from a top view, this absence of a flush edge in particular on the external surface 240 of the dowel 200.

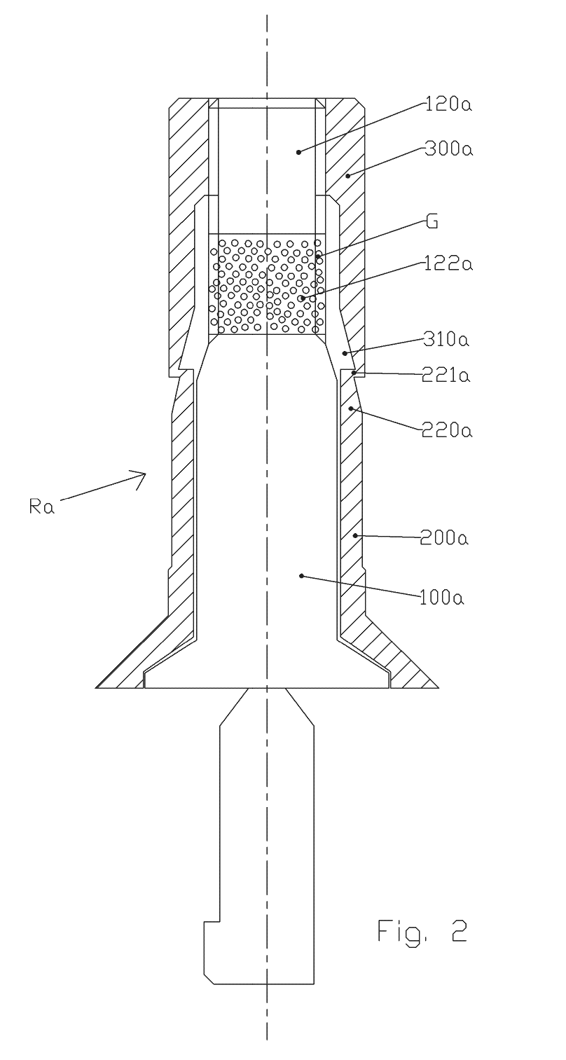

The embodiment shown by the drawing of FIG. 2 differs from the one described above in that the nut 300a constitutes, in a first step with the dowel 200a, a single part, being associated with the latter by a connection zone 221a of which said tensile force exerted in the translation movement causes the breakage. Thus, under the action of the tensile force transmitted by the rod 100a, the connection zone 221a breaks and allows the nut 300a to expand around the end 220a of the dowel 200a.

This FIG. 2 supports the illustration of another particularly advantageous feature that can be applied to all of the embodiments. According to the invention and the embodiment shown, the threaded portion 120a of the rod 100a can be broken down into:
a first zone 121a of threads starting from the end of the rod, which have been screwed into the threads of the nut 300a and which ensures the connection with this nut 300a in the inactive position and during transmission of the translation movement;
a second zone 122a of threads comprising a deposit of an adhesive material G, and which is not in contact with the nut 300a during the transmission of the translation movement but cooperates with the latter during the screwing movement.

This feature helps to optimise the attachment created by the invention.

According to a preferred embodiment, this adhesive material G is deposited in the form of microcapsules on the threading.

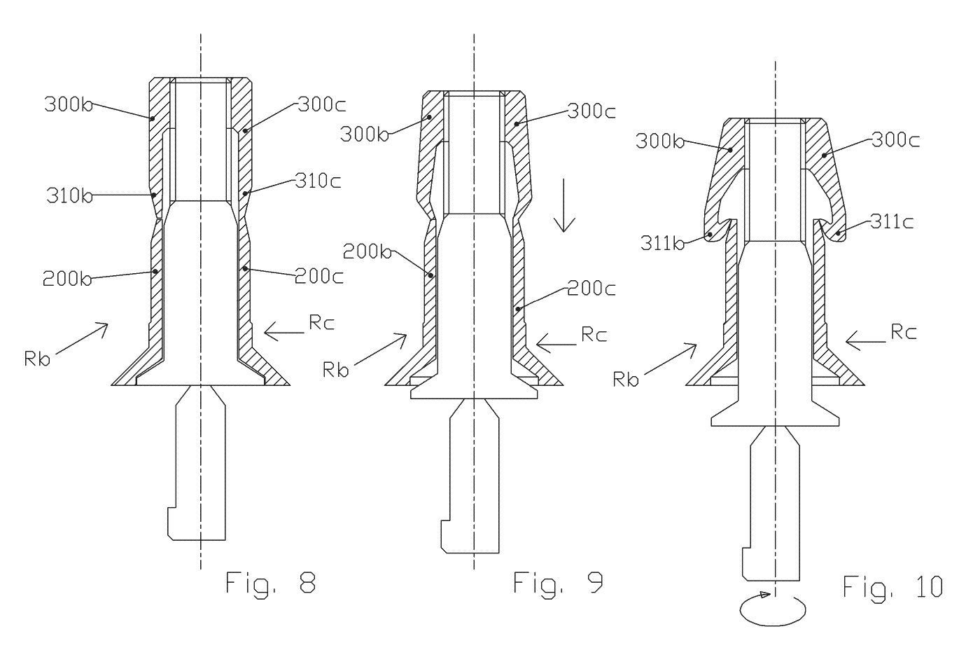

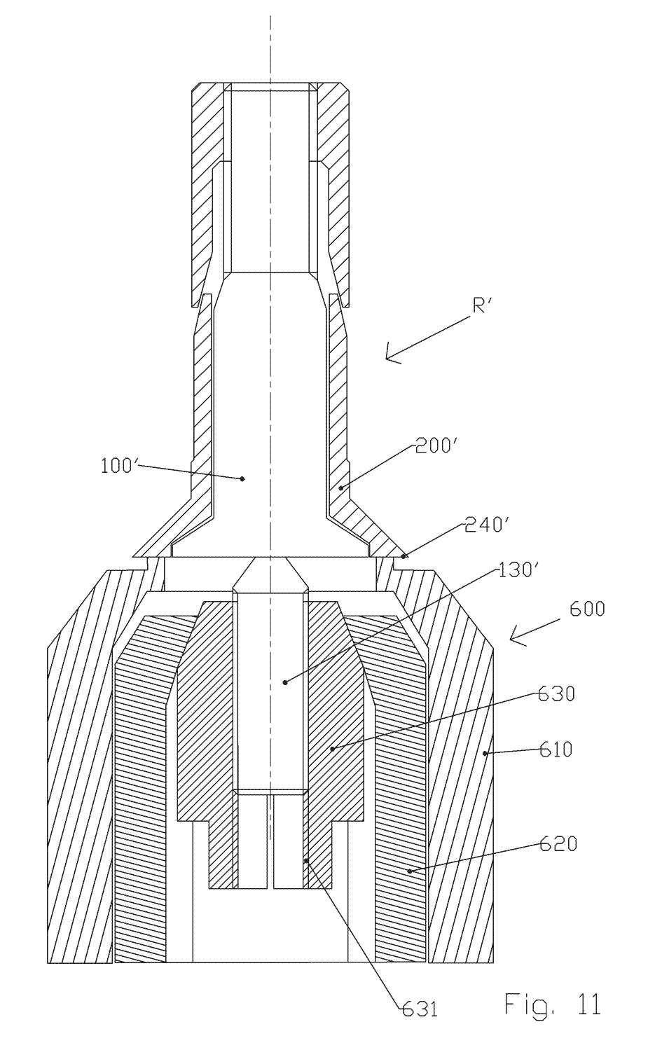

According to the embodiments shown by the drawings of FIGS. 8, 9, and 10, the rivet Rb shown on the left side of the axis and the rivet Rc shown on the right side have the special feature of a nut 300b and 300c that is preformed in its lower portion 310b and 310c so as to expand by bending outwardly and forming, by this bending, a bead 311b and 311c. These rivets Rb and Rc enable an optimised attachment because this bead defines a contact surface that is broader and farther from the edge of the hole formed in the element to be attached. FIGS. 8, 9 and 10 show the progression of the bending formed in the first tensile force phase of the method of the invention. The second phase of screwing is not shown, since it is equivalent.

Although they have a substantially equivalent external form, the rivets Rb and Rc differ in that the dowel consists of two parts for the embodiment Rb with a nut 300b independent of the dowel 200b, and one part for the embodiment Bc with a nut 300c independent of the dowel 200c.

According to a preferred embodiment, the rod can be made of hard-drawn stainless steel, titanium, etc.

The dowel can be made of stainless steel, titanium, Inconel, etc.

The nut can be made of stainless steel, titanium, aluminium, etc.

As shown in the drawing of FIG. 11, the fitting tool and in particular the fitting nose 600 of said rivet R′ implementing said method is constituted by:
a stationary body 610 coming into contact, on each side of the actuation rod 130′, with the external surface 240′ of the head of the dowel 200′;
an actuation member 620 housed in the body 600 and capable of being moved in translation and in rotation so as to cause the movement of a gripping member 630 with which the actuation rod 130′ cooperates.

According to another particularly advantageous feature, and in accordance with the embodiment shown, the gripping member 630 housed in the actuation member 620 is equipped with an internal threading 631 in which the actuation rod 130′ is screwed, which rod is itself threaded so as to be secured to said griping member 630 on transmission of the translation or rotation movement. This choice of a helical connection for the transmission of a movement not only in translation but also in rotation makes the production of the actuation rod 130′ particularly simple.

It is understood that the attachment method and the blind rivet, which have been described and shown above, have been done so for the purpose of disclosure rather than limitation. Of course, various arrangements, modifications and improvements can be made to the example above, without going beyond the scope of the invention.

1. Method for structural attachment of two elements in which attachment apertures are provided and made coaxial
which method uses a blind rivet positioned in the attachment apertures and including a rod that, equipped with a head and a threaded portion, is arranged inside a hollow dowel including
a first end equipped with a head that constitutes a first bearing surface on a first element, and
a second end on which a nut cooperating with the threaded portion of the rod exerts a force transmitted by the rod so that a second bearing surface on the second element is created by deformation, characterised in that it includes
imparting a first translation movement on the rod so as to create, by deformation under the action of said nut, said second bearing surface cooperating with the surface defined by the head of the dowel in order to assume the attachment between the two elements, then
imparting a second rotation movement on said rod for the purpose of screwing, so as to apply a tension in the attachment created.

2. Method for structural attachment of two elements in which attachment apertures are provided and made coaxial, which method uses a blind rivet constituted by a rod that, equipped with a countersunk head and a threaded portion, is arranged inside a hollow dowel including
a first end externally adopting the form of a countersunk head constituting a first bearing surface and preformed internally by a conical volume in order to receive the countersunk head of the rod, and
a second end on which a nut cooperating with the rod exerts a tensile force transmitted by the rod so that a second bearing surface is created by deformation, characterised in that it includes
imparting a first translation movement on the rod so as to create, by deformation, said second bearing surface cooperating with the surface defined by the countersunk head of the dowel in order to assume the attachment, then
imparting a second rotation movement on said rod for the purpose of screwing, so as to apply a tension in the attachment created.

3. Method according to claim 1, characterised in that the tensile force ensures the tight assembly of the dowel inside the first traversed element to be attached.

4. Method according to claim 1, characterised in that it includes when the rod moves in translation, causing the nut to deform around the second end of the dowel so as to create the second bearing surface.

5. Blind rivet enabling the method of claim 1 to be implemented, characterised in that the rod is threaded only at its end so as to be helically connected only to the nut and adopts a sliding pivot-type connection with the dowel.

6. Blind rivet enabling the method of claim 1 to be implemented, characterised in that it comprises an actuation rod associated with the head of the rod by means of a connection zone of which the cross-section is defined to facilitate its breakage once a tightening torque has been achieved, which rod adopts a profile allowing its tensile as well as its rotational movement.

7. Blind rivet according to claim 6, characterised in that the actuation rod comprises an external surface preformed with a threading.

8. Blind rivet enabling the method according to claim 1 to be implemented, characterised in that the nut is associated with the dowel by a connection zone of which said tensile force exerted in the translation movement ensures the breakage.

9. Blind rivet enabling the method according to claim 1 to be implemented, characterised in that the dowel adopts a bulge under its head so that the head of the dowel requires an additional force for its insertion into the aperture provided for receiving it in the part to be attached.

10. Blind rivet enabling the method according to claim 1 to be implemented, characterised in that the nut and/or the end of the dowel with which it comes into contact adopt surfaces opposing said rotation once the deformation has been achieved.

11. Blind rivet enabling the method according to claim 1 to be implemented, characterised in that the threaded portion of the rod can be broken down into:
a first zone of threads starting from the end of the rod, which have been screwed into the threads of the nut and which ensures the connection with this nut (300a) in the inactive position and during transmission of the translation movement;
a second zone of threads comprising a deposit of an adhesive material, and which is not in contact with the nut during the transmission of the translation movement but cooperates with the latter during the screwing movement.

12. Blind rivet enabling the method according to claim 1 to be implemented, characterised in that the external surface of the head of the dowel has a planar surface coming to the same height as the surface of the element to be attached and not comprising any projecting or retracted volume.

13. Fitting tool comprising a fitting nose suitable for the method according to claim 1, characterised in that the fitting nose is constituted by
a stationary body coming into contact, on each side of the actuation rod, with the external surface of the dowel head;
an actuation member housed in the body and capable of being moved in translation and in rotation so as to cause the movement of a gripping member (630) with which the actuation rod cooperates.

14. Fitting tool comprising a fitting nose suitable for the method according to claim 13, characterised in that the gripping member housed in the actuation member is equipped with an internal threading with which the actuation rod engages, which rod is itself threaded so as to be secured to said gripping member upon the transmission of the translation and rotation movement.

15. Method according to claim 2 wherein the tensile force promotes the tight assembly of the dowel inside the first traversed element to be attached.

16. Method according to claim 2 wherein it includes, when the rod moves in translation, causing the nut to deform around the second end of the dowel so as to create the second bearing surface.

17. Blind rivet for the method of claim 2 to be implemented, wherein the rod is threaded only at its end so as to be helically connected only to the nut and adopts a sliding pivot-type connection with the dowel.

18. Blind rivet for the method of claim 2 to be implemented, wherein it comprises an actuation rod associated with the head of the rod by means of a connection zone of which the cross-section is defined to facilitate its breakage once a tightening torque has been achieved, which rod adopts a profile allowing its tensile as well as its rotational movement.

19. Blind rivet according to claim 6, wherein the actuation rod comprises an external surface preformed with a threading.

20. Blind rivet enabling the method according to claim 2 to be implemented, wherein the nut is associated with the dowel by a connection zone of which the tensile force exerted in the translation movement promotes the breakage.

21. Blind rivet enabling the method according to claim 2 to be implemented, wherein the dowel adopts a bulge under its head so that the head of the dowel requires an additional force for its insertion into the aperture provided for receiving it in the part to be attached.

22. Blind rivet enabling the method according to claim 2 to be implemented, wherein the nut and/or the end of the dowel with which it comes into contact adopt surfaces opposing the rotation once the deformation has been achieved.

23. Blind rivet enabling the method according to claim 2 to be implemented, wherein the threaded portion of the rod can be broken down into:
a first zone of threads starting from the end of the rod, which have been screwed into the threads of the nut and which promotes the connection with this nut in the inactive position and during transmission of the translation movement;
a second zone of threads comprising a deposit of an adhesive material, and which is not in contact with the nut during the transmission of the translation movement but cooperates with the latter during the screwing movement.

24. Blind rivet enabling the method according to claim 2 to be implemented, wherein the external surface of the head of the dowel has a planar surface coming to the same height as the surface of the element to be attached and not comprising any projecting or retracted volume.

25. Fitting tool comprising a fitting nose suitable for the method according to claim 2, wherein the fitting nose is constituted by
a stationary body coming into contact, on each side of the actuation rod, with the external surface of the dowel head;
an actuation member housed in the body and capable of being moved in translation and in rotation so as to cause the movement of a gripping member with which the actuation rod cooperates.

26. Fitting tool comprising a fitting nose suitable for the method according to claim 25, wherein the gripping member housed in the actuation member is equipped with an internal threading with which the actuation rod engages, which rod is itself threaded so as to be secured to the gripping member upon the transmission of the translation and rotation movement.
